(19) United States
(12) Patent Application Publication
(10) Pub. No.: US 2006/0104507 A1
(43) Pub. Date: May 18, 2006

(54) Correction of image color levels

(75) Inventor: George C. John, Austin, TX (US)

Correspondence Address: ANDERSON & JANSSON, L.L.P., 9501 N. CAPITAL OF TX HWY. #202, AUSTIN, TX, 78759, US

(73) Assignee: SozoTek, Inc.

(21) Appl. No.: 11/060,970

(22) Filed: Feb. 18, 2005

Related U.S. Application Data
(60) Provisional application No. 60/628,175, filed on Nov. 15, 2004.

(51) Int. Cl. G06K 9/00

(52) U.S. Cl. 382/167

(57) ABSTRACT

Provided is a computer system and method for processing images. A method for applying a color bias correction for an image includes but is not limited to, separating high frequency data from low frequency data of the image; using the high frequency data to determine one or more local minima; applying a function of the local minima to determine a black level; using the high frequency data to determine one or more local maxima; applying a function of the local maxima to determine a white level; and correcting the color bias of the image by linearly interpolating the image between one or more values associated with the white level and one or more values associated with the black level.

### CROSS-REFERENCE TO RELATED APPLICATION

This application claims priority to U.S. Provisional Ser. No. 60/628,175, filed Nov. 15, 2004, having the same inventor, and is incorporated herein by reference in its entirety.

### TECHNICAL FIELD

The present application relates generally to the field of processing image data, and, more particularly to color bias correction.

### SUMMARY

In one aspect a method for applying a color bias correction for an image includes but is not limited to, separating high frequency data from low frequency data of the image; using the high frequency data to determine one or more local minima; applying a function of the local minima to determine a black level; using the high frequency data to determine one or more local maxima; applying a function of the local maxima to determine a white level; and correcting the color bias of the image by linearly interpolating the image between one or more values associated with the white level and one or more values associated with the black level. According to the method, the separating high frequency data from low frequency data of the image includes representing the image as an intensity image; high pass filtering the intensity image; and converting the filtered intensity image to a weighting map.

The using the high frequency data to determine one or more local minima includes, but is not limited to converting the image to an intensity image; filtering the intensity image to acquire the high frequency data; zeroing all positive values from the high frequency data to obtain a negative mapping; and inverting the negative mapping.

The using the high frequency data to determine one or more local maxima includes but is not limited to converting the image to an intensity image; filtering the intensity image to acquire the high frequency data; zeroing all negative values from the high frequency data to acquire a positive mapping; and normalizing the positive mapping.

In another aspect, a method for determining a black level for an image includes, but is not limited to, locating one or more local minima in the image; averaging red, blue and green values at the one or more local minima; and setting the averaged red, blue, and green values at the one or more local minima as a neutral black level.

In an embodiment, the setting the averaged red, blue, and green values at the one or more local minima as a neutral black level includes applying one or more spatial averages to determine local variations, which can be performed via one or more Gaussian blur functions.

In another aspect, a method determining a white level for an image, includes, but is not limited to locating one or more local minima in the image; averaging red, blue and green values at the one or more local minima; setting the averaged red, blue, and green values at the one or more local minima as a neutral black level; locating one or more local maxima in the image; averaging red, blue and green values at the one or more local maxima; and setting the averaged red, blue, and green values at the one or more local maxima as a white level relative to the neutral black level.

In an embodiment, the averaging red, blue and green values at the one or more local minima and the averaging red, blue and green values at the one or more local maxima includes determining a black level weighting map; determining a white level weighting map; multiplying the red, blue and green values by the white level weighting map and the black level weighting map; and performing a spatial averaging.

In an embodiment, one or more of the black level weighting map and the white level weighting map are adjusted by weighting the blue values according to the function 0.6B+0.4R, wherein B represents blue pixels and R represents red pixels.

In another aspect, a method for a receiving one or more color bias corrected images includes, but is not limited to connecting with an image storing and/or generating device, the image storing and/or generating device generating and/or storing one or more images, the device transmitting the one or more images to a server; and downloading the one or more color bias corrected images from the server, the server color bias correcting the one or more images, the color bias correcting including: separating high frequency data from low frequency data of the image; using the high frequency data to determine one or more local minima; applying a function of the local minima to determine a black level; using the high frequency data to determine one or more local maxima; applying a function of the local maxima to determine a white level; and correcting the color bias of the image by linearly interpolating the image between one or more values associated with the white level and one or more values associated with the black level.

In one aspect, a system includes, but is not limited to a processor; a memory coupled to the processor; and an image processing module coupled to the memory, the image processing module configurable to: separate high frequency data from low frequency data of the image; use the high frequency data to determine one or more local minima; apply a function of the local minima to determine a black level; use the high frequency data to determine one or more local maxima; apply a function of the local maxima to determine a white level; and correct the color bias of the image by linearly interpolating the image between one or more values associated with the white level and one or more values associated with the black level.

In one aspect, a computer program product includes a computer readable medium configured to perform one or more acts for determining a black level for an image, including but is not limited to locating one or more local minima in the image; averaging red, blue and green values at the one or more local minima; and setting the averaged red, blue, and green values at the one or more local minima as a neutral black level.

In another aspect, a computer program product includes a computer readable medium configured to perform one or more acts for determining a color bias correction for an image, the one or more acts including but not limited to separating high frequency data from low frequency data of the image; using the high frequency data to determine one or more local minima; applying a function of the local minima to determine a black level; using the high frequency data to determine one or more local maxima; applying a function of the local maxima to determine a white level; and correcting the color bias of the image by linearly interpolating the image between one or more values associated with the white level and one or more values associated with the black level.

The foregoing is a summary and thus contains, by necessity, simplifications, generalizations and omissions of detail; consequently, those skilled in the art will appreciate that the summary is illustrative only and is NOT intended to be in any way limiting. Other aspects, features, and advantages of the devices and/or processes and/or other subject described herein will become apparent in the text set forth herein.

### BRIEF DESCRIPTION OF THE DRAWINGS

A better understanding of the subject matter of the present application can be obtained when the following detailed description of the disclosed embodiments is considered in conjunction with the following drawings, in which:

FIG. 1 is a block diagram of an exemplary computer architecture that supports the claimed subject matter;

FIG. 2 is a block diagram of a network environment appropriate for embodiments of the subject matter of the present application.

FIG. 3 is a flow diagram illustrating a method in accordance with an embodiment of the present application.

FIG. 4 is a flow diagram illustrating a method in accordance with an embodiment of the present application.

FIG. 5 is a graph representation of the pixel values in a digital image and locating the local minima in accordance with an embodiment of the present application.

FIG. 6 is a flow diagram illustrating a method in accordance with an embodiment of the present application.

FIG. 7 is a graph representation of before and after results from performing a high pass filter on the high and low frequency values of a digital image in accordance with an embodiment of the present application.

FIG. 8 is a graph representation of taking the absolute value of a digital image and normalizing in accordance with an embodiment of the present application.

FIG. 9 is a flow diagram illustrating a method in accordance with an embodiment of the present application.

FIG. 10 is a flow diagram illustrating a method in accordance with an embodiment of the present application.

FIG. 11 is a flow diagram illustrating a method in accordance with an embodiment of the present application.

### DETAILED DESCRIPTION OF THE DRAWINGS

Those with skill in the computing arts will recognize that the disclosed embodiments have relevance to a wide variety of applications and architectures in addition to those described below. In addition, the functionality of the subject matter of the present application can be implemented in software, hardware, or a combination of software and hardware. The hardware portion can be implemented using specialized logic; the software portion can be stored in a memory or recording medium and executed by a suitable instruction execution system such as a microprocessor.

Digital images often show a color bias in certain areas that is not aesthetically pleasing. For example, a black background may have a reddish cast, or a white shirt may have a greenish cast. Color bias can be caused by a variety of factors, such as limitations in the sensors and lens of the device used to capture the image and distortions caused by the means of illumination. Fluorescent lighting, for example, tends to give a greenish cast to white areas in a color photograph.

Color bias represents a distortion in the alignment of the minima intensity (low pixel values) of the red, green, and blue planes in an image because of the limitations of digital imaging. The degree of misalignment may not be uniform across different regions of the image and can be different in the shadows, highlights, and mid tones of the image.

For example, in a completely black area of a digital image, the pixel intensity values of red, blue, and green should be equal. Such a condition, where red, green and blue have equal values in a black area, may be called the true black level for the area. The limitations of digital imaging can cause distortions in the different color frequency bands of a captured digital image, so that in one area of the image the red band has a higher intensity than it should. As a result, that area will have a red bias; that is, the black in that area will have a reddish cast. In other areas, the green band may have a higher intensity than it should, relative to the intensities of the red and blue bands there, causing a greenish cast. The blue band may show similar distortions in other areas, causing a bluish cast.

Digital images marred by color bias often need correction to make them more aesthetically pleasing. For example, because of the greenish cast under fluorescent lighting, cameras often pre-set their white balance to correct white by subtracting green from it. However, when black, white, and mid gray are set to predetermined levels, problems with color bias still tend to occur. For example, darkest pixel in an image might not really represent black but a dark red. The present disclosure is directed to addressing color bias distortions.

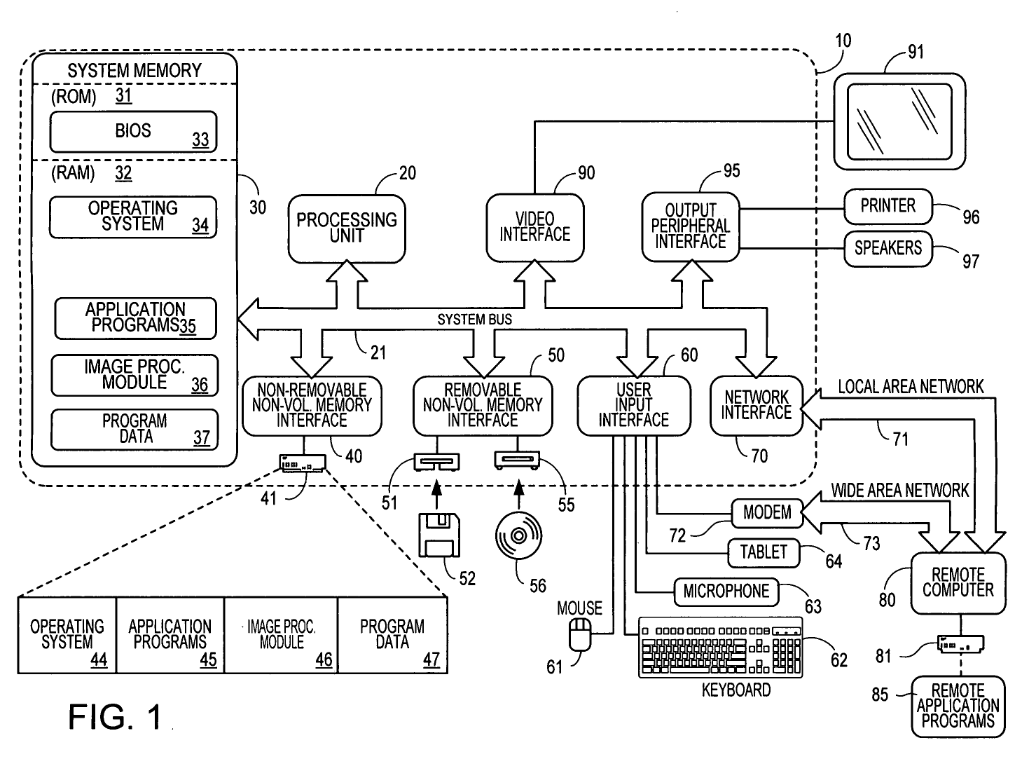

With reference to FIG. 1, an exemplary computing system for implementing the embodiments and includes a general purpose computing device in the form of a computer 10. Components of the computer 10 may include, but are not limited to, a processing unit 20, a system memory 30, and a system bus 21 that couples various system components including the system memory to the processing unit 20. The system bus 21 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 10 typically includes a variety of computer readable media. Computer readable media can be any available media that can be accessed by the computer 10 and includes both volatile and nonvolatile media, and removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computer 10. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 30 includes computer storage media in the form of volatile and/or nonvolatile memory such as read only memory (ROM) 31 and random access memory (RAM) 32. A basic input/output system 33 (BIOS), containing the basic routines that help to transfer information between elements within computer 10, such as during start-up, is typically stored in ROM 31. RAM 32 typically contains data and/or program modules that are immediately accessible to and/or presently being operated on by processing unit 20. By way of example, and not limitation, FIG. 1 illustrates operating system 34, application programs 35, other program modules 36 and program data 37. FIG. 1 is shown with program modules 36 including an image processing module in accordance with an embodiment as described herein.

The computer 10 may also include other removable/non-removable, volatile/nonvolatile computer storage media. By way of example only, FIG. 1 illustrates a hard disk drive 41 that reads from or writes to non-removable, nonvolatile magnetic media, a magnetic disk drive 51 that reads from or writes to a removable, nonvolatile magnetic disk 52, and an optical disk drive 55 that reads from or writes to a removable, nonvolatile optical disk 56 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 41 is typically connected to the system bus 21 through a non-removable memory interface such as interface 40, and magnetic disk drive 51 and optical disk drive 55 are typically connected to the system bus 21 by a removable memory interface, such as interface 50. An interface for purposes of this disclosure can mean a location on a device for inserting a drive such as hard disk drive 41 in a secured fashion, or a in a more unsecured fashion, such as interface 50. In either case, an interface includes a location for electronically attaching additional parts to the computer 10.

The drives and their associated computer storage media, discussed above and illustrated in FIG. 1, provide storage of computer readable instructions, data structures, program modules and other data for the computer 10. In FIG. 1, for example, hard disk drive 41 is illustrated as storing operating system 44, application programs 45, other program modules, including image processing module 46 and program data 47. Program modules 46 is shown including an image processing module, which can be configured as either located in modules 36 or 46, or both locations, as one with skill in the art will appreciate. More specifically, image processing modules 36 and 46 could be in non-volatile memory in some embodiments wherein such an image processing module runs automatically in an environment, such as in a cellular phone. In other embodiments, image processing modules could be part of a personal system on a hand-held device such as a personal digital assistant (PDA) and exist only in RAM-type memory. Note that these components can either be the same as or different from operating system 34, application programs 35, other program modules, including queuing module 36, and program data 37. Operating system 44, application programs 45, other program modules, including image processing module 46, and program data 47 are given different numbers hereto illustrate that, at a minimum, they are different copies. A user may enter commands and information into the computer 10 through input devices such as a tablet, or electronic digitizer, 64, a microphone 63, a keyboard 62 and pointing device 61, commonly referred to as a mouse, trackball or touch pad. Other input devices (not shown) may include a joystick, game pad, satellite dish, scanner, or the like. These and other input devices are often connected to the processing unit 20 through a user input interface 60 that is coupled to the system bus, but may be connected by other interface and bus structures, such as a parallel port, game port or a universal serial bus (USB). A monitor 91 or other type of display device is also connected to the system bus 21 via an interface, such as a video interface 90. The monitor 91 may also be integrated with a touch-screen panel or the like. Note that the monitor and/or touch screen panel can be physically coupled to a housing in which the computing device 10 is incorporated, such as in a tablet-type personal computer. In addition, computers such as the computing device 10 may also include other peripheral output devices such as speakers 97 and printer 96, which may be connected through an output peripheral interface 95 or the like.

The computer 10 may operate in a networked environment using logical connections to one or more remote computers, which could be other cell phones with a processor or other computers, such as a remote computer 80. The remote computer 80 may be a personal computer, a server, a router, a network PC, PDA, cell phone, a peer device or other common network node, and typically includes many or all of the elements described above relative to the computer 10, although only a memory storage device 81 has been illustrated in FIG. 1. The logical connections depicted in FIG. 1 include a local area network (LAN) 71 and a wide area network (WAN) 73, but may also include other networks. Such networking environments are commonplace in offices, enterprise-wide computer networks, intranets and the Internet. For example, in the subject matter of the present application, the computer system 10 may comprise the source machine from which data is being migrated, and the remote computer 80 may comprise the destination machine. Note however that source and destination machines need not be connected by a network or any other means, but instead, data may be migrated via any media capable of being written by the source platform and read by the destination platform or platforms.

When used in a LAN or WLAN networking environment, the computer 10 is connected to the LAN through a network interface or adapter 70. When used in a WAN networking environment, the computer 10 typically includes a modem 72 or other means for establishing communications over the WAN 73, such as the Internet. The modem 72, which may be internal or external, may be connected to the system bus 21 via the user input interface 60 or other appropriate mechanism. In a networked environment, program modules depicted relative to the computer 10, or portions thereof, may be stored in the remote memory storage device. By way of example, and not limitation, FIG. 1 illustrates remote application programs 85 as residing on memory device 81. It will be appreciated that the network connections shown are exemplary and other means of establishing a communications link between the computers may be used.

In the description that follows, the subject matter of the application will be described with reference to acts and symbolic representations of operations that are performed by one or more computers, unless indicated otherwise. As such, it will be understood that such acts and operations, which are at times referred to as being computer-executed, include the manipulation by the processing unit of the computer of electrical signals representing data in a structured form. This manipulation transforms the data or maintains it at locations in the memory system of the computer which reconfigures or otherwise alters the operation of the computer in a manner well understood by those skilled in the art. The data structures where data is maintained are physical locations of the memory that have particular properties defined by the format of the data. However, although the subject matter of the application is being described in the foregoing context, it is not meant to be limiting as those of skill in the art will appreciate that some of the acts and operation described hereinafter can also be implemented in hardware.

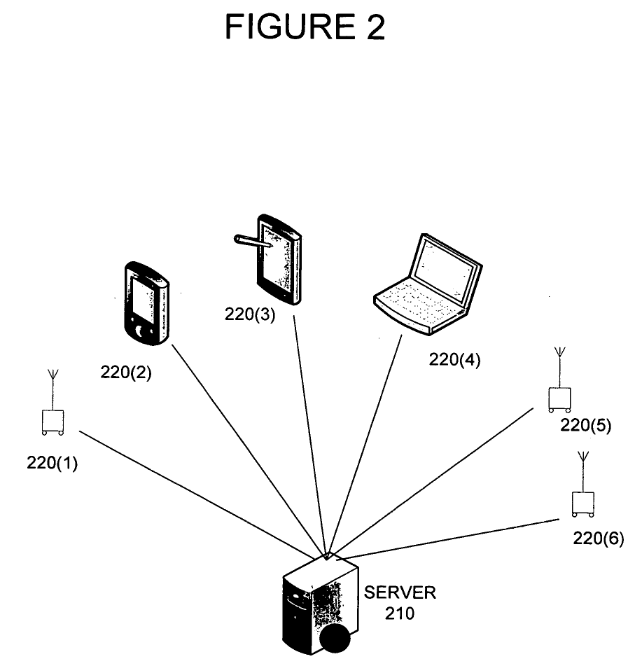

Referring to FIG. 2, a diagram of a network appropriate for embodiments herein is shown. The network includes a server 210. The term “server” as used herein refers to a computing device configurable to be a decision-making device in the context of an environment, which could be a network, having at least two computing devices, one of which being a controllable component. Components 220 as shown in FIG. 2 can be configurable to be controllable components. Alternatively, one or more of components 220 can be configurable to operate as a “server” if they are configurable to be decision-making devices capable of performing at least some of the acts as disclosed herein, as one of skill in the art with the benefit of the present application will appreciate. A “server” may be substantially any decision-making device for purposes of the present application capable of performing in a fashion similar to that described herein and outwardly appearing as a mobile or stationary device, such as a personal computer (PC), a pager, a personal digital assistant (PDA), a wired or wireless telephone, or the like. As one of skill in the art appreciates, the form of a computing device typically relates to the function of a computing device with respect to the size of the form required to hold components for computing as required by a system. Thus, many forms for holding a “server” are within the scope of that term as described herein.

Server 210 can be a printer with communication capabilities to connect with a plurality of wireless components or wired components 220, which can be interact with server 210 via wireless or wired connection 230. Connection 230 could include a wireless local area network connection (WLAN), a radio frequency (RF) connection or other method of wireless or wired communication of data. Other wireless and wired communication connections can include a satellite connection or the like as one of skill in the art with the benefit of the present disclosure will appreciate.

Components 220 can include receivers and transmitters to interact with server 210. Components 220 are shown including different types of components, including component 220(1) which could be a simple device capable of only receiving and displaying data. Component 220(2) is shown as a personal electronic assistant, which could be configured to both send and/or receive data generated by server 210. Component 220(3) is shown as a tablet personal computer (PC) can also be configured to both send and/or receive data. Component 220(4) is shown as a laptop or notebook computer which can also send and/or receive data. Components 220(5) could be implemented as a simple mobile device for displaying images. Component 220(6) could be implemented as a cellular telephone configurable to display images in accordance with embodiments herein.

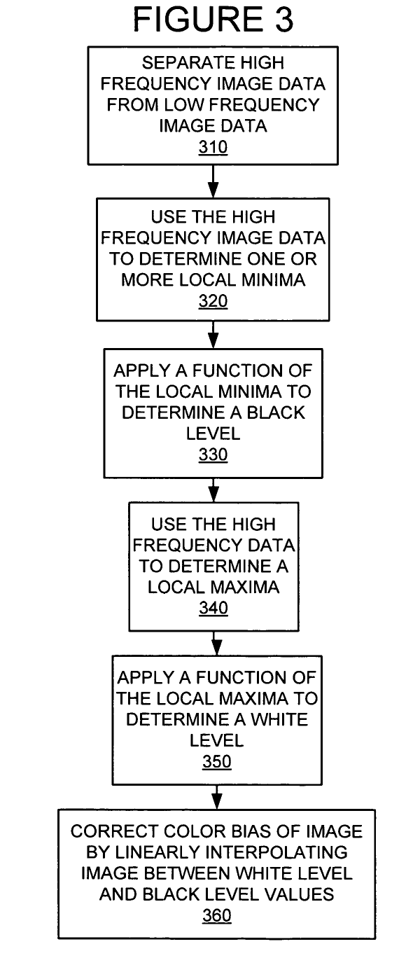

Referring now to FIG. 3, a flow diagram illustrates an embodiment for image color correction processing. Image processing modules 36 and 46 can be configurable to enhance images collected by a digital camera, and, more particularly, perform color biasing of digital images. More specifically, FIG. 3 illustrates a flow diagram for image processing modules 36 and 46 shown in FIG. 1. Block 310 provides for separating high frequency image data from low frequency image data of the image. Block 320 provides for using the high frequency data to determine the local minima. Block 330 provides for applying a function of the local minima to determine a black level. The local minima enables determining an average of the color in each shadow area of an image and finding an offset for black associated with the average. Block 340 provides for using the high frequency data to determine the local maxima. Block 350 provides for applying a function of the local maxima to determine a white level. The local maxima enable determining an average of the color in each bright area of the image and determining a white offset associated with the average. Block 360 provides for correcting the color bias of the image by linearly interpolating the image between one or more values associated with the white level and one or more values associated with the black level.

Regarding the linear interpolation, one method for interpolating can include providing a white level W(x,y), providing a black level B(x,y) and an image I(x,y), applying the following formula:

$${I}_{k} ( x , y ) = \frac{{I}_{k} ( x , y ) - {B}_{k} ( x , y )}{{W}_{k} ( x , y ) - {B}_{k} ( x , y )}$$

where k=R,G,B for each color plane. One of skill in the art will appreciate that R,G,B represents red, green, and blue plane and can also represent similar components, such as other color planes such as yellow, magenta, cyan, and the like.

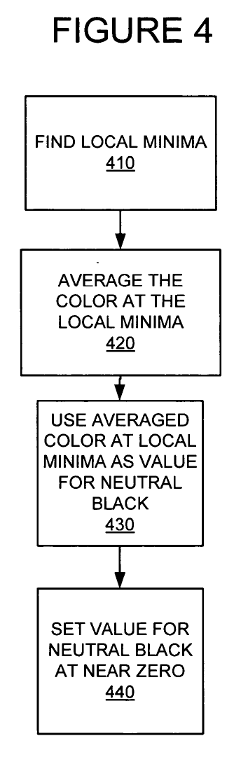

Referring to FIG. 4, a method for determining a black level is provided. Block 410 provides for determining an image's local minima. More particularly, a neutral black area can vary at different regions and points of an image. In an embodiment, modules 36 and 46 are configurable to determine the true black level locally to the different regions of an image by working with that image's local minima.

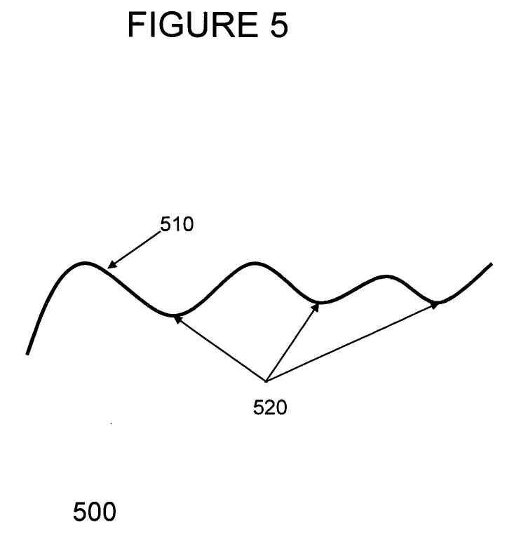

Referring to FIG. 4 in combination with FIG. 5, FIG. 5 illustrates a one-dimensional representation 500 of the pixel values 510 for one color band in a typical digital image. The digital image could include but not be limited to an image of a natural scene. The low points in the graph 500 are called local minima 520 and represent shadows, meaning dark areas.

Block 420 provides for averaging the color at the local minima of an image. Block 430 provides for using the averaged color at the local minima to determine a value for neutral black. Block 440 provides for setting the value for neutral black at near zero, where the red, green, and blue values of the image are equal. In one embodiment, the setting the value is determined by first creating a weighting map and using the weighting map to determine a black level correction.

For example, this process can be used to correct a digital image of a natural scene with pixel values ranging from 0 to 1 in red, green and blue. In other embodiments, images with other ranges of values can be used.

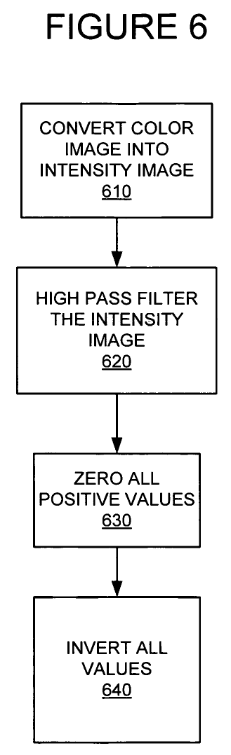

FIG. 6 illustrates a one-dimensional representation of the high and low frequency values of one line in a color band for such an image.

Referring now to FIG. 6 a flow diagram illustrates a method for determining a weighting map. Block 610 provides for converting the color image into an intensity image in monochrome by averaging the red, green, and blue bands. One method for converting a color image into an intensity image is by adding the red, green, and blue components and dividing by three. Another method for converting a color image into an intensity image is by taking the square root of the sum of the squares method: \sqrt{(R²+G²+B²)÷3}. Another method could be determining the intensity according to a known intensity related to the colors, such as Y=0.059G+0.29R+0.12B.

Block 620 provides for high pass filtering the intensity image. The filtering separates the high and low frequency detail of the image. The high pass filtering leaves high frequency oscillations, which can be removed by clipping, as further explained herein. The high frequency details can then be operated on without affecting the low frequency details of the image. Within the high frequency details, local variations in intensity within the image become visible with the negative values representing the local minima. In one embodiment, not just one high pass filter is used, but multiple high pass filters are applied at different radii, such that different frequency bands are weighted separated to make a ramp type high pass filter. For example, a ramp filter multiplied by a Butterworth type filter can be applied to more accurately provide the weighting map.

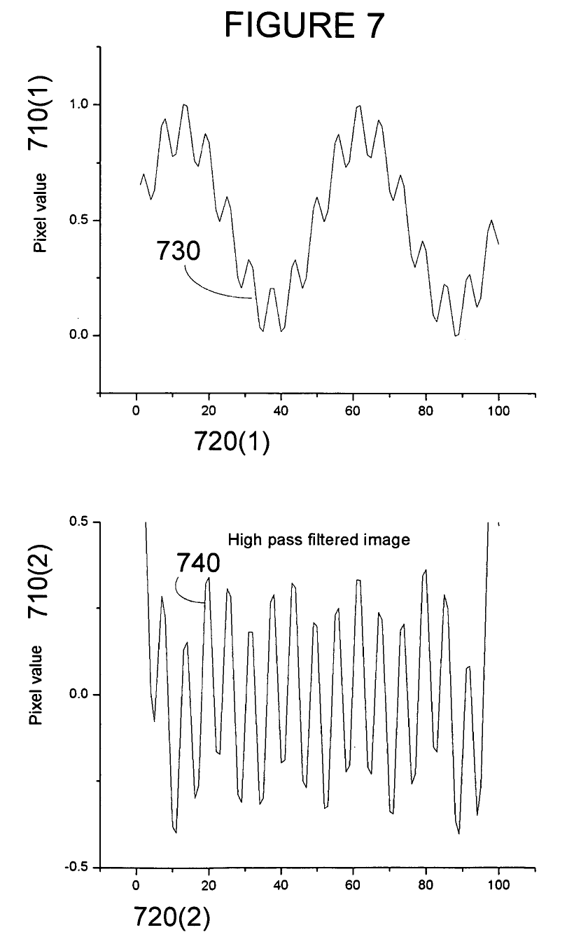

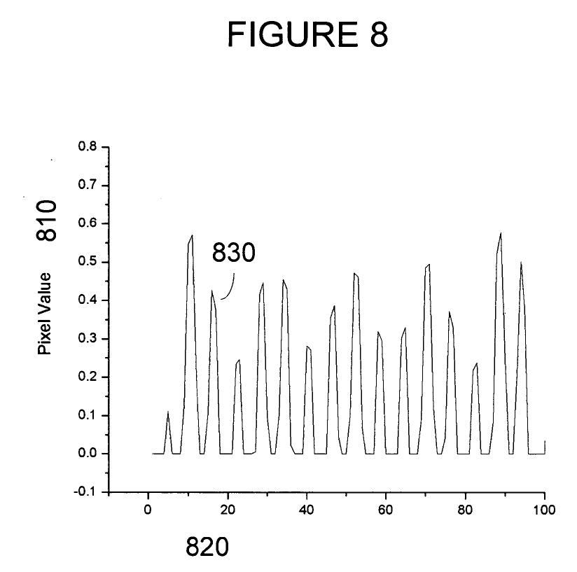

Referring to FIG. 7, a one-dimensional example illustrates the result of performing high pass filtering according to the method described in FIG. 6. The graph illustrates image values 730 with the pixel values 710(1) at different frequencies 720(1), and the same pixel values 710(2) after high pass filtering 720(2) as shown by data 740. The FIG. 8 illustrates a one-dimensional example 820 illustrates the result of performing the adding high pass filtering on the pixel values shown in FIG. 7.

Block 630 provides for zeroing all positive values to leave only the negative values representing shadow areas. In one embodiment, any value below −0.5 is clipped to provide −0.5. Next, block 640 provides for inverting the image values. One method of inverting the image values is by determining the absolute value of the resulting image and then normalizing. Another method of inverting the image values is by multiplying the image by a negative number. In one embodiment the image values are multiplied by −2. The result after multiplying by −2 can be used as a black level weighting map. Another method for inverting the image can include inverting the image by subtracting each pixel value from one. The methods for inverting the image provide weight to the darker areas of an image and providing less weight to lighter areas of an image. The multiplying creates a weighting map with higher values in the darker local minima zones and near zero values in the highlights.

The weighting map provides a map highlighting where the darker areas of the image are located. The weighting map can then be multiplied by the data representing each color: Wm*R; Wm*G; Wm*B, with R representing red pixels, G representing green pixels, and B representing blue pixels. The weighting map provides the color weighting for the darker areas for black level correction. Thus, if an image includes a smooth cloth or sky area, the high pass filter prevents affecting such constant colored areas and addresses only the high frequency material, such as a fold in an otherwise constant colored dress. The colors, R, G, and B can be adjusted to more accurately take into account properties of the different colors. Thus, for example, red can be adjusted to be the minimum(R,G) and blue can be adjusted in an embodiment. More particularly, in one embodiment, refinement of the method for creating the weighting map includes adjusting for blue color. In the embodiment, blue is weighted by adding red. One embodiment uses the formula Bnew=0.6B+0.4R, where B represents blue pixels and R represents red pixels. Next, a parameter offset, referred to herein as “Maxcolor” is set equal to the max(R, G, Bnew) so that each pixel is set as the maximum of R, G and Bnew. Next, a weighting map for black level is corrected by multiplying the weighting map by Maxcolor. By multiplying the weighting map by Maxcolor, any biases due to bright secondary colors can be prevented.

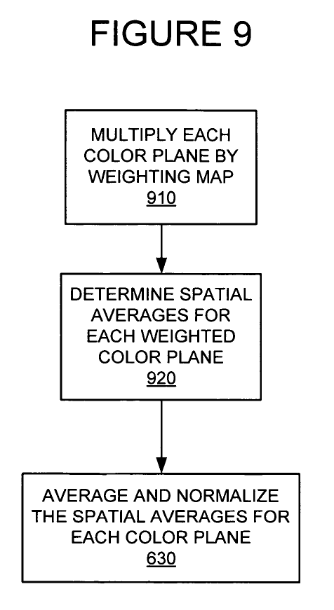

Referring now to FIG. 9, a flow diagram illustrates a method for applying a weighting map to determine black level correction. Block 910 provides for multiplying each color plane by the weighting map. The result provides three weighted color planes. Block 920 provides for applying spatial averages to each weighted color plane. In one embodiment, for each color plane, a spatial average is determined by applying a Gaussian blur function to each color plane. An example of a Gaussian blur is an infinite impulse response (IIR) Gaussian blur that displaces pixels in a radius from a predetermined central point. In one embodiment the spatial average is determined by first performing several local spatial averages on each weighted color plane with progressively increasing kernel sizes, up to the size of the whole image. More particularly, a small kernel representing different radii raging from 20 pixels to the entire image to achieve a local averaging of the high frequency shadows for each color plane. For example, an embodiment provides for using five spatial averaging operations with different radii sizes ranging from 20 pixels to the size of the image. In one embodiment, a smaller radius of 20 pixels provides local variation in the black level. The local averaging can progress until the whole image is averaged and a single value for each color plane is determined. The average determines an estimate of the black level specific to a local region within the image. Block 930 provides for determining for each color plane an averaged and normalized spatial average. More particularly, for each color plane, the several local spatial averages are added together and normalized by taking the sum and dividing the sum by the number of spatial averages for each color plane. The adding and normalizing the pixel intensity values of the spatial averages provides a color bias for the image and includes at least a neutral black level of the image.

The result of the normalization process is a derived black correction that can then be applied to the image to increase or decrease pixel intensity values appropriately to create a corrected image. In one embodiment, a system implementing the correction subtracts the correction from the image or divides the image by the black level correction as determined by system requirements.

In one embodiment, methods similar to those described above can be applied to correct the white and gray levels of digital images.

Correcting the White Level

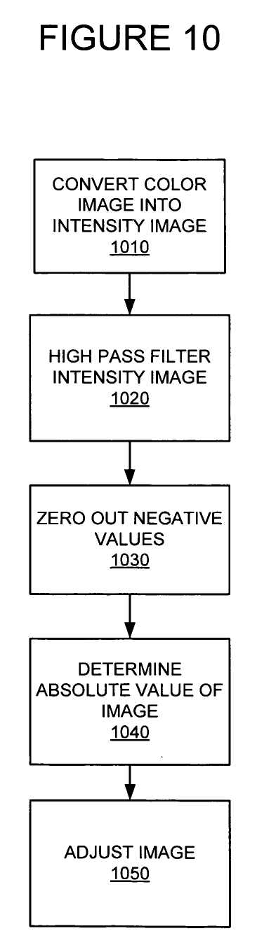

In an embodiment, the process for correcting the white level in an image is similar to the method the same as that given above for the black level. Referring now to FIG. 10, a flow diagram illustrates a method for determining a weighting map appropriate for correcting a white level. Block 1010 provides for converting the color image into an intensity image by averaging the red, green, and blue frequency bands. Block 1020 provides for high pass filtering the intensity of the image so that the highest frequencies are separated. Block 1030 provides for zeroing out negative values. In one embodiment, the method provides for clipping any values above 0.5 to 0.5. Block 1040 provides for determining an absolute value of the resulting image. Block 1050 provides for adjusting the resulting image. The adjustment can be accomplished by multiplying the image values by 2 or by normalizing the resulting image. The normalization can be between zero and one.

In one embodiment, a bright color adjustment is made for blues. In the embodiment, blue is weighted by adding red, similar to the method for adjusting black levels. One embodiment uses the formula Bnew=0.6B+0.4R, where B represents blue pixels and R represents red pixels. One of skill in the art will appreciate that other formulas for adding red are within the scope of the present disclosure and can be image dependent. Next, a parameter offset, referred to herein as “Mincolor” is set equal to the min(R, G, Bnew) so that each pixel is set as the minimum of R, G and Bnew. Next, a weighting map for black level is corrected by multiplying the weighting map by Mincolor. By multiplying the weighting map by Mincolor, any biases due to bright primary colors can be prevented.

After determining an appropriate weighting map for the white level, a system according to embodiments herein performs the method described with respect to FIG. 9. More particularly, a spatial average for each color plane (R, G and B) is determined. A Gaussian blur function represents one spatial averaging method appropriate for an embodiment. More particularly, for each color plane, the several local spatial averages are added together and normalized by taking the sum and dividing the sum by the number of spatial averages for each color plane. The adding and normalizing the pixel intensity values of the spatial averages provides a color bias for the image and includes a white level of the image.

The result of the normalization process is a derived white level correction that can then be applied to the image to increase or decrease pixel intensity values appropriately to create a corrected image. In one embodiment, a system implementing the correction can add the correction from the image as determined by system requirements.

Correcting the Gray Level

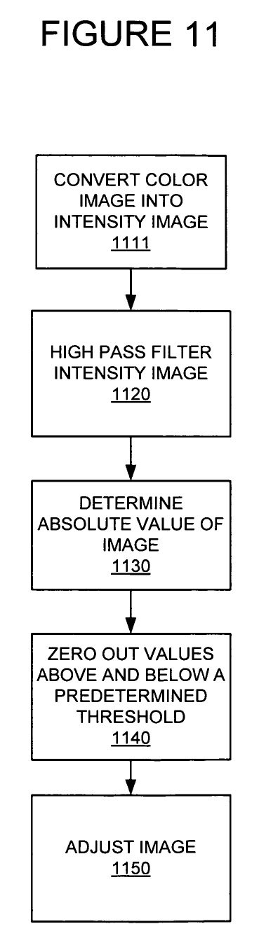

Referring now to FIG. 11, an embodiment provides for correcting the gray level in an image by altering the methods provided above for determining a weighting map. Block 1110 provides for converting a color image into an intensity image by averaging the red, green, and blue bands. Block 1120 provides for high pass filtering the intensity of the image so that the highest frequencies are separated. Block 1130 provides for determining the absolute value of the image. Block 1140 provides for zeroing out values above a pre-determined threshold, wherein the threshold is a small positive value. In one example, 0.1 can be used as a useful threshold value.

Block 1150 provides for normalizing the resulting image. Block 1160 provides for multiplying the intensity image, by the normalized image.

After an appropriate weighting map for the gray level is determined, the method described with respect to FIG. 7 is performed. More particularly, a spatial average for each color plane is determined. A Gaussian blur function represents one spatial averaging method appropriate for an embodiment.

The methods described above for color bias correction are appropriate for use in a microprocessor in an image capturing device or in software used in a computing environment. The color bias methods estimate a black level based on the minima (low intensity pixel values) and white level based on the maxima (high intensity pixel values) of individual color planes. Software can use the estimates to determine the degree of deviation from the neutral black level and white level in each color band. The software then uses the derived degree of deviation in the color bands to increase or decrease the intensity of the color bands to neutralize the local black level and to correct a white level. Thus, the intensity values of the red, green, and blue color bands are equal. By equalizing the intensity values of the red, green and blue color bands, an image processing system removes color bias from black areas and white areas in an image. Similar processes can be used to correct the gray level.

It will be apparent to those skilled in the art that many other alternate embodiments of the present invention are possible without departing from its broader spirit and scope. Moreover, in other embodiments the methods and systems presented can be applied to other types of signal than signals associated with camera images, comprising, for example, medical signals and video signals.

While the subject matter of the application has been shown and described with reference to particular embodiments thereof, it will be understood by those skilled in the art that the foregoing and other changes in form and detail may be made therein without departing from the spirit and scope of the subject matter of the application, including but not limited to additional, less or modified elements and/or additional, less or modified steps performed in the same or a different order.

Those having skill in the art will recognize that the state of the art has progressed to the point where there is little distinction left between hardware and software implementations of aspects of systems; the use of hardware or software is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in standard integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies equally regardless of the particular type of signal bearing media used to actually carry out the distribution. Examples of a signal bearing media include, but are not limited to, the following: recordable type media such as floppy disks, hard disk drives, CD ROMs, digital tape, and computer memory; and transmission type media such as digital and analog communication links using TDM or IP based communication links (e.g., packet links).

The herein described aspects depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected” , or “operably coupled” , to each other to achieve the desired functionality, and any two components capable of being so associated can also be viewed as being “operably couplable” , to each other to achieve the desired functionality. Specific examples of operably couplable include but are not limited to physically mateable and/or physically interacting components and/or wirelessly interactable and/or wirelessly interacting components and/or logically interacting and/or logically interactable components.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of this subject matter described herein. Furthermore, it is to be understood that the invention is defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more” ); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.).

We claim:

1. A method for determining a correction for a color bias of an image comprising:
separating high frequency data from low frequency data of the image;
using the high frequency data to determine one or more local minima;
applying a function of the local minima to determine a black level;
using the high frequency data to determine one or more local maxima;
applying a function of the local maxima to determine a white level; and
correcting the color bias of the image by linearly interpolating the image between one or more values associated with the white level and one or more values associated with the black level.

2. The method of claim 1 wherein the separating high frequency data from low frequency data of the image includes:
representing the image as an intensity image;
high pass filtering the intensity image; and
converting the filtered intensity image to a weighting map.

3. The method of claim 1 wherein the using the high frequency data to determine one or more local minima includes:
converting the image to an intensity image;
filtering the intensity image to acquire the high frequency data;
zeroing all positive values from the high frequency data to obtain a negative mapping; and
inverting the negative mapping.

4. The method of claim 1 wherein the using the high frequency data to determine one or more local maxima includes one or more of:
converting the image to an intensity image;
filtering the intensity image to acquire the high frequency data;
zeroing all negative values from the high frequency data to acquire a positive mapping; and
normalizing the positive mapping.

5. The method of claim 1 further comprising:
determining an absolute value of the high frequency data; and
zeroing values above and below a predetermined threshold to determine a gray level adjustment for the image.

6. The method of claim 2 further comprising:
applying one or more spatial averages to determine local variations.

7. The method of claim 6 wherein the one or more spatial averages are performed via one or more Gaussian blur functions.

8. A method for determining a black level for an image, the method comprising:
locating one or more local minima in the image;
averaging red, blue and green values at the one or more local minima; and
setting the averaged red, blue, and green values at the one or more local minima as a neutral black level.

9. The method of claim 8 further comprising:
setting the neutral black level as near zero.

10. The method of claim 8 wherein the locating one or more local minima in the image includes:
converting the image to an intensity image;
applying one or more high pass filters to the intensity image to acquire high frequency data;
zeroing all positive values from the high frequency data to obtain a negative mapping; and
inverting the negative mapping to acquire a weighted mapping.

11. The method of claim 8 wherein the setting the averaged red, blue, and green values at the one or more local minima as a neutral black level includes applying one or more spatial averages to determine local variations.

12. The method of claim 11 wherein the one or more spatial averages are performed via one or more Gaussian blur functions.

13. The method of claim 10 wherein the averaging red, blue and green values at the one or more local minima includes:
multiplying the weighted mapping by the red, blue and green values; and
determining one or more local spatial averages using the red, blue, and green values multiplied by the weighted mapping.

14. A method for determining a white level for an image, the method comprising:
locating one or more local minima in the image;
averaging red, blue and green values at the one or more local minima;
setting the averaged red, blue, and green values at the one or more local minima as a neutral black level;
locating one or more local maxima in the image;
averaging red, blue and green values at the one or more local maxima; and
setting the averaged red, blue, and green values at the one or more local maxima as a white level relative to the neutral black level.

15. The method of claim 14 wherein the averaging red, blue and green values at the one or more local minima and the averaging red, blue and green values at the one or more local maxima includes:
determining a black level weighting map;
determining a white level weighting map;
multiplying the red, blue and green values by the white level weighting map and the black level weighting map; and
performing a spatial averaging.

16. The method of claim 15 wherein one or more of the black level weighting map and the white level weighting map are adjusted by weighting the blue values according to a function B′=0.6B+0.4R, wherein B represents blue pixels and R represents red pixels.

17. The method of claim 16 wherein one or more of the black level weighting map and the white level weighting map are adjusted by weighting each pixel as a maximum of R, G and B′.

18. The method of claim 16 wherein one or more of the black level weighting map and/or the white level weighting map are adjusted by weighting each pixel as a minimum of R, G and B′.

19. A method for a receiving one or more color bias corrected images, the method comprising:
connecting with an image storing and/or generating device, the image storing and/or generating device generating and/or storing one or more images, the device transmitting the one or more images to a server; and
downloading the one or more color bias corrected images from the server, the server color bias correcting the one or more images, the color bias correcting including:
separating high frequency data from low frequency data of the image;
using the high frequency data to determine one or more local minima;
applying a function of the local minima to determine a black level;
using the high frequency data to determine one or more local maxima;
applying a function of the local maxima to determine a white level; and
correcting the color bias of the image by linearly interpolating the image between one or more values associated with the white level and one or more values associated with the black level.

20. A computer system comprising:
a processor;
a memory coupled to the processor;
an image processing module coupled to the memory, the image processing module configurable to:
separate high frequency data from low frequency data of the image;
use the high frequency data to determine one or more local minima;
apply a function of the local minima to determine a black level;
use the high frequency data to determine one or more local maxima;
apply a function of the local maxima to determine a white level; and
correct the color bias of the image by linearly interpolating the image between one or more values associated with the white level and one or more values associated with the black level.

21. A computer program product comprising a computer readable medium configured to perform one or more acts for determining a black level for an image, the one or more acts comprising:
locating one or more local minima in the image;
averaging red, blue and green values at the one or more local minima; and
setting the averaged red, blue, and green values at the one or more local minima as a neutral black level.

22. A computer program product comprising a computer readable medium configured to perform one or more acts for determining a color bias correction for an image, the one or more acts comprising:
separating high frequency data from low frequency data of the image;
using the high frequency data to determine one or more local minima;
applying a function of the local minima to determine a black level;
using the high frequency data to determine one or more local maxima;
applying a function of the local maxima to determine a white level; and
correcting the color bias of the image by linearly interpolating the image between one or more values associated with the white level and one or more values associated with the black level.
